(19) United States
(12) Patent Application Publication
(10) Pub. No.: US 2012/0286204 A1
(43) Pub. Date: Nov. 15, 2012

(54) METAL FLUORIDE CRYSTAL, VACUUM ULTRAVIOLET LIGHT EMITTING ELEMENT, AND VACUUM ULTRAVIOLET LIGHT EMITTING SCINTILLATOR

(76) Inventors: Noriaki Kawaguchi, Shunan-shi (JP); Sumito Ishizu, Shunan-shi (JP); Kentaro Fukuda, Shunan-shi (JP); Toshihisa Suyama, Shunan-shi (JP); Akira Yoshikawa, Sendai-shi (JP); Takayuki Yanagida, Sendai-shi (JP); Yui Yokota, Sendai-shi (JP); Naoto Abe, Sendai-shi (JP)

(21) Appl. No.: 13/519,040

(22) PCT Filed: Dec. 22, 2010
(86) PCT No.: PCT/JP2010/073174

§ 371 Date: Jun. 25, 2012

(30) Foreign Application Priority Data
Dec. 25, 2009 (JP) 2009-294829

(51) Int. Cl. C09K 11/85

(52) U.S. Cl. 252/301.4 H

(57) ABSTRACT

[Problems to be Solved] A fluoride which emits light with high brightness in a vacuum ultraviolet region is provided. Also provided are a novel vacuum ultraviolet light emitting element which comprises the fluoride and which can be suitably used in photolithography, cleaning of a semiconductor or liquid crystal substrate, sterilization, next-generation large-capacity optical disks, medical care (ophthalmologic treatment, DNA cleavage), etc.; and a vacuum ultraviolet light emitting scintillator which is composed of the fluoride and can be suitably used in a small-sized radiation detector incorporating a diamond light receiving element or AlGaN light receiving element with a low background noise as an alternative to a conventional photomultiplier tube.

[Means to Solve the Problems] A metal fluoride crystal represented by a chemical formula K_{3-X}Na_{X}Tm_{YZ}Lu_{Y(1-Z)}F_{3+3Y} where 0.7<X<1.3, 0.85<Y<1.1 and 0.001≦Z<1.0, such as K₂NaTm_{0.4}Lu_{0.6}F₆, K_{2.1}Na_{0.9}TmF₆, K₂NaTmF₆, or K₂NaTm_{0.9}F_{5.7}; a vacuum ultraviolet light emitting element composed of the crystal; and a vacuum ultraviolet light emitting scintillator composed of the crystal.

[Selected Drawing] None

### TECHNICAL FIELD

This invention relates to a novel metal fluoride crystal. The metal fluoride crystal can be used preferably as a vacuum ultraviolet light emitting element for use in photolithography, cleaning of a semiconductor or liquid crystal substrate, sterilization, next-generation large-capacity optical disks, medical care (ophthalmological treatment, DNA cleavage), etc., and as a vacuum ultraviolet light emitting scintillator for a radiation detector which is used for cancer diagnosis by PET or for X-ray CT.

### BACKGROUND ART

A high brightness ultraviolet light emitting element is a material backing up high technologies in the semiconductor field, the information field, the medical field, and so forth. In recent years, the development of ultraviolet light emitting elements which emit light at shorter wavelengths has been under way in order to satisfy numerous demands, including that for an increase in a recording density on a recording medium. An LED with a light emission wavelength of about 360 nm, which comprises an ultraviolet light emitting material such as GaN, is commercially available as an ultraviolet light emitting element which emits light at a short wavelength.

A vacuum ultraviolet light emitting material with a shorter light emission wavelength of 200 nm or less can also be used preferably, as a vacuum ultraviolet light emitting element, for photolithography, cleaning of a semiconductor or liquid crystal substrate, sterilization, etc., so that its development is desired. However, it is not easy to obtain such a vacuum ultraviolet light emitting element, and only a few examples of the element are known.

The elements which emit light upon irradiation with radiation can also be used as scintillators. A radiation detector for use in PET-based cancer diagnosis or X-ray CT is composed of a combination of a material which emits light when irradiated with radiation, called a scintillator, and a low-light-level photodetector such as a photomultiplier tube or a semiconductor light receiving element.

As the low-light-level photodetectors, photomultiplier tubes or Si light receiving elements are predominantly used. In recent years, however, vacuum ultraviolet light receiving elements using diamond or AlGaN as a light receiving surface have been developed. These light receiving elements, as compared with conventional Si semiconductor light receiving elements, do not sense visible light having lower energy than that of vacuum ultraviolet light. Hence, these light receiving elements can realize a low background noise, and they are promising for incorporation into a radiation detector. Therefore, the development of a new vacuum ultraviolet light emitting scintillator preferred for these light receiving elements is desired.

Since visible light receiving elements have hitherto been used, scintillator crystals exhibiting visible light emission have been mainly developed, and vacuum ultraviolet light emitting scintillators have not been fully investigated.

An example is a Nd-doped lanthanum fluoride crystal (see Non-Patent Document 1). This crystal achieves short wavelength light emission at 175 nm in comparison with LSO (Ce-doped Lu-based oxide: light emission wavelength about 400 nm) already in practical sue as a single crystal scintillator for a medical diagnostic instrument, but mainly contains La (atomic number Z=57), which has a lower atomic number than that of Lu (Z=71), as a base material. The atomic number of La is relatively high among all elements, and the Nd-doped lanthanum fluoride crystal has satisfactory stopping power over gamma rays, but its stopping power is not sufficient compared with that of LSO.

The cause of the difficulty in developing a vacuum ultraviolet light emitting material is, for example, that substances which do not cause self-absorption are limited, because vacuum ultraviolet rays are absorbed by many substances.

Furthermore, light emission characteristics in the vacuum ultraviolet region are susceptible to impurities in materials. Even a material having the energy level for light emission in the vacuum ultraviolet region often fails to provide desired vacuum ultraviolet light emission, for a reason such that light emission at a long wavelength based on a lower energy level is predominant, or that a loss due to nonradiative transition is severe.

Hence, it is extremely difficult to predict the light emission characteristics in the vacuum ultraviolet region. This constitutes a big barrier to the development of a vacuum ultraviolet light emitting element.

### PRIOR ART DOCUMENTS

### Non-Patent Documents:

Non-Patent Document 1: P. SHOTAUS et al., “DETECTION OF LaF3:Nd3+ SCINTILLATION LIGHT IN A PHOTOSENSITIVE MULTIWIRE CHAMBER” Nuclear Instruments and Methods in Physics Research A272, 913-916 (1988).

### DISCLOSURE OF THE INVENTION

### Problems to be Solved by the Invention

It is an object of the present invention to provide a metal fluoride crystal which emits light with high brightness in the vacuum ultraviolet region. It is another object of the present invention to provide a novel vacuum ultraviolet light emitting element which comprises the metal fluoride crystal and which can be suitably used in photolithography, cleaning of a semiconductor or liquid crystal substrate, sterilization, next-generation large-capacity optical disks, medical care (ophthalmologic treatment, DNA cleavage), etc.; and a vacuum ultraviolet light emitting scintillator which comprises the metal fluoride crystal and which is used for a radiation detector for use in cancer diagnosis by PET or in X-ray CT.

### Means for Solving the Problems

The present inventors searched for materials emitting light in the vacuum ultraviolet region, and conducted various studies. As a result, they have found that a metal fluoride crystal prepared using a composition, in which part of potassium (K) of a metal fluoride crystal represented by a chemical formula K₃LuF₆ has been replaced by sodium (Na), part of lutetium (Lu) of the metal fluoride crystal has been replaced by thulium (Tm), and further the ratio between the total atomic number of K and Na and the total atomic number of Tm and Lu has been changed, emits light with high brightness at a wavelength in the vacuum ultraviolet region when this crystal is excited with radiation. They have also found that the K₃LuF₆ crystal has deliquescent properties, but can be reduced in deliquescent properties by having part of its K replaced by Na. These findings have led them to accomplish the present invention.

That is, the present invention is a metal fluoride crystal represented by a chemical formula K_{3-X}Na_{X}Tm_{YZ}Lu_{Y(1-Z)}F_{3+3Y} where 0.7<X<1.3, 0.85<Y<1.1, and 0.001≦Z≦1.0.

In this invention of the metal fluoride crystal, the preferred metal fluoride crystal is one in which Y=1, 0.9≦X≦1.0, and 0.05≦Z≦0.4, namely, a metal fluoride crystal represented by the chemical formula K_{3-X}Na_{X}Tm_{Z}Lu_{1-Z}F₆ where 0.9≦X≦1.0 and 0.05≦Z≦0.4.

Other aspects of the present invention are a vacuum ultraviolet light emitting element composed of the metal fluoride crystal, and a vacuum ultraviolet light emitting scintillator composed of the metal fluoride crystal.

### Effects of the Invention

With the metal fluoride crystal represented by the chemical formula K_{3-X}Na_{X}Tm_{YZ}Lu_{Y(1-Z)}F_{3+3Y} where 0.7<X<1.3, 0.85<Y<1.1, and 0.001≦Z≦1.0 according to the present invention, light emission with high brightness in the vacuum ultraviolet region can be obtained by irradiation with radiation.

The vacuum ultraviolet light emitting element composed of the crystal can be used preferably in photolithography, cleaning of a semiconductor or liquid crystal substrate, sterilization, next-generation large-capacity optical disks, medical care (ophthalmologic treatment, DNA cleavage), etc. It can also be used preferably as a scintillator for a vacuum ultraviolet low-light-level photodetector such as a diamond light receiving element or an AlGaN light receiving element.

Moreover, the metal fluoride crystal of the present invention is low in deliquescent properties, and can be handled in the atmosphere. Hence, it is advantageous in that it can be produced or processed even if not within drying facilities whose humidity is specially controlled.

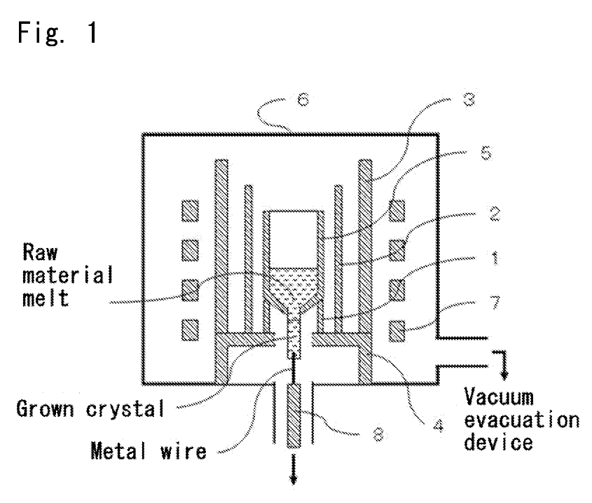

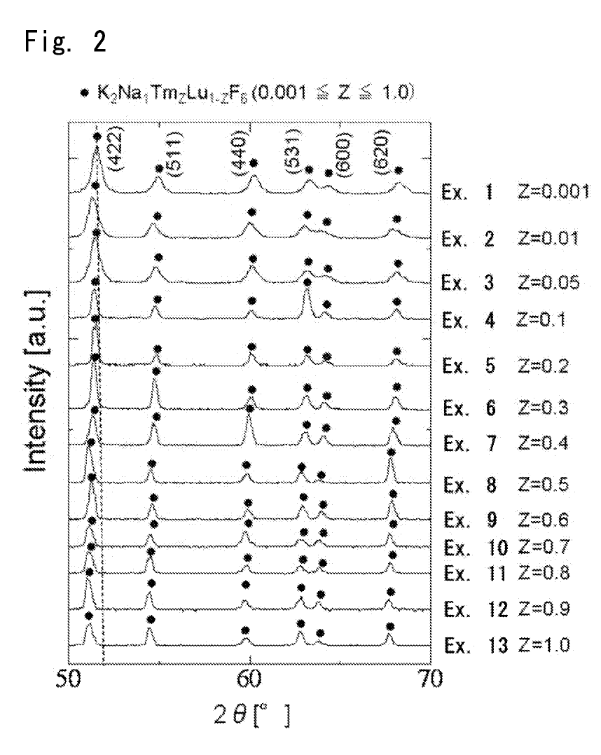

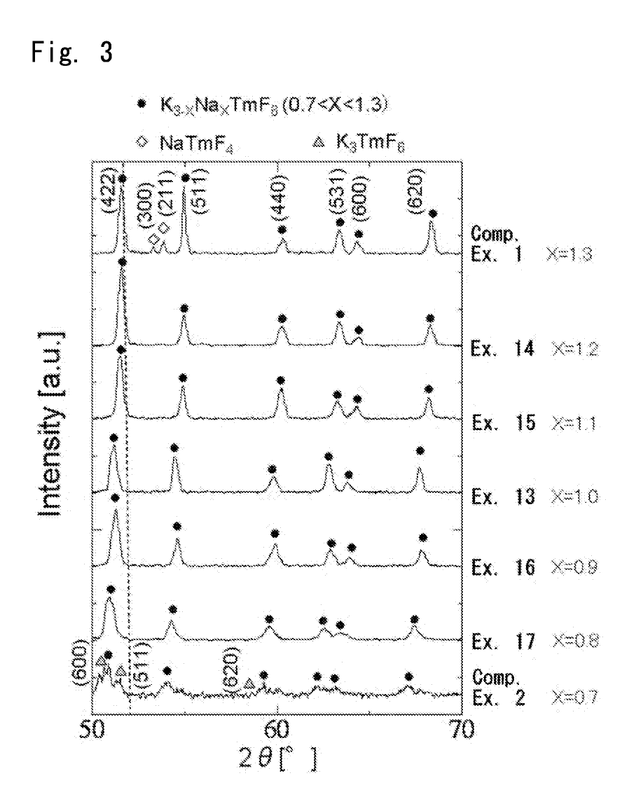

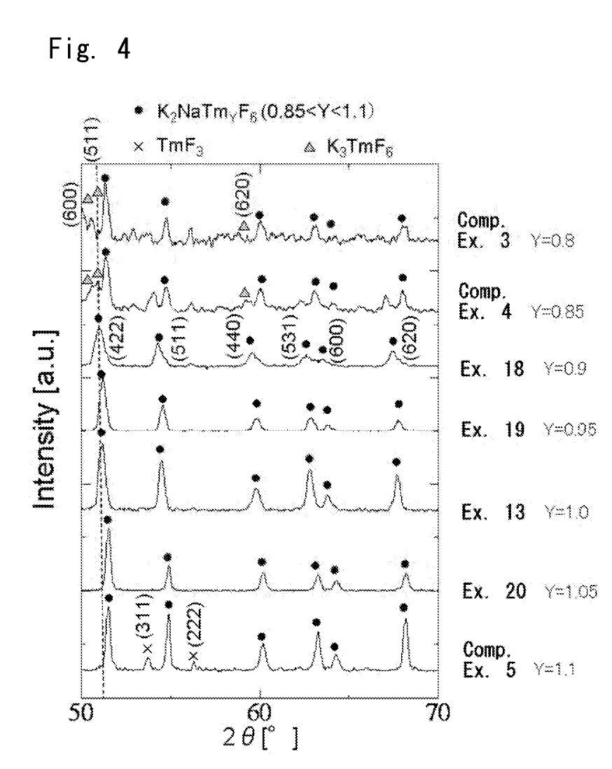

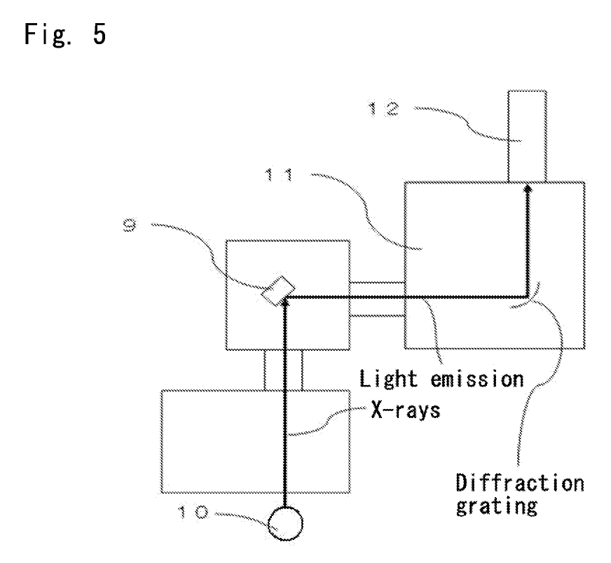

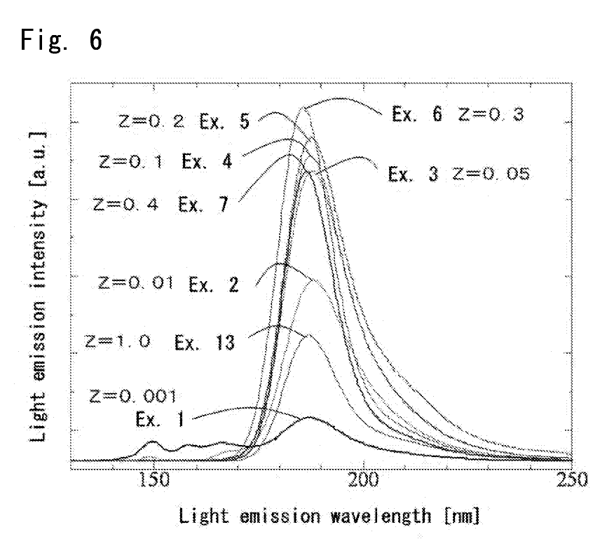

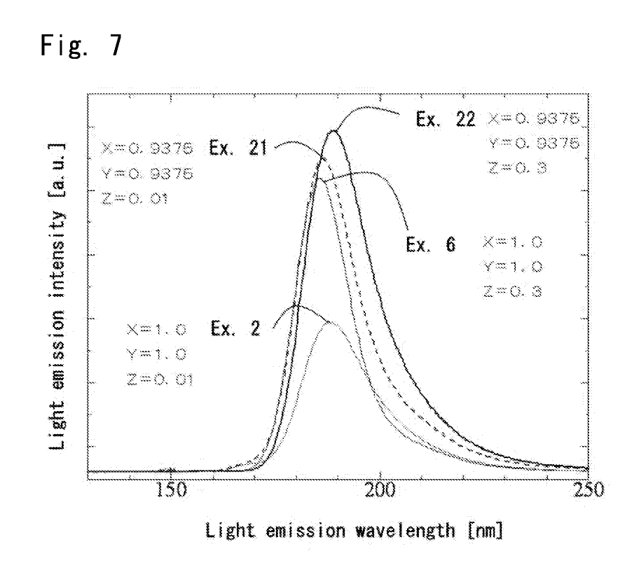

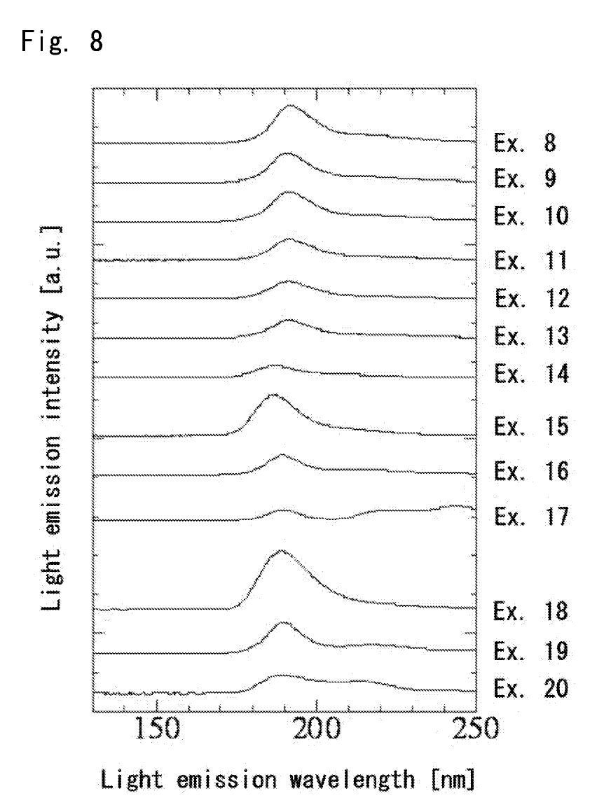

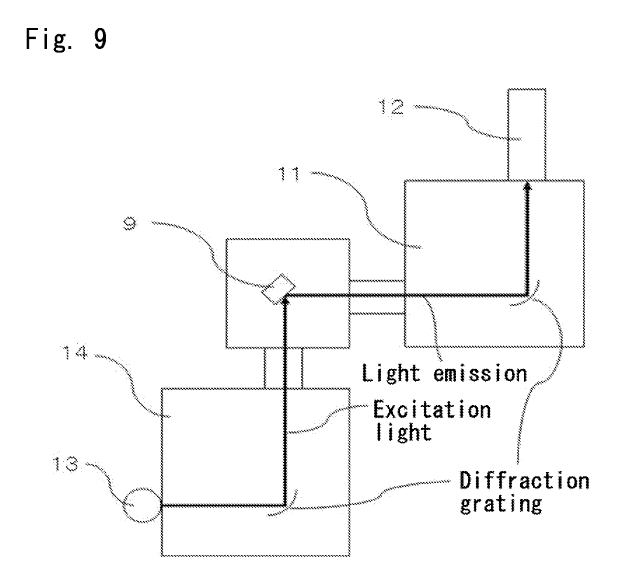

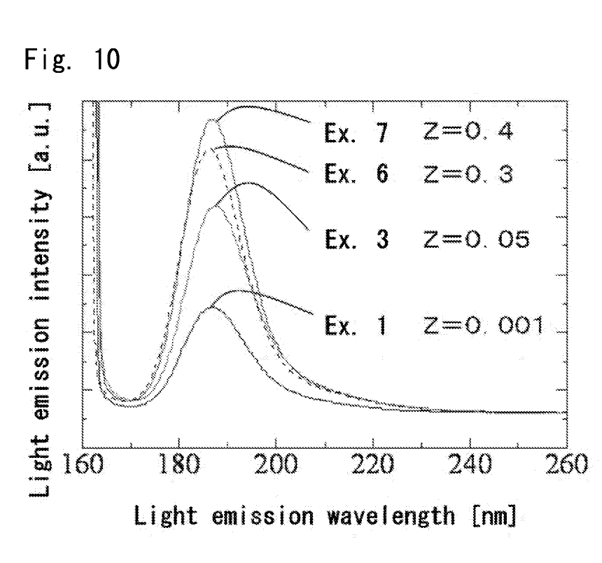

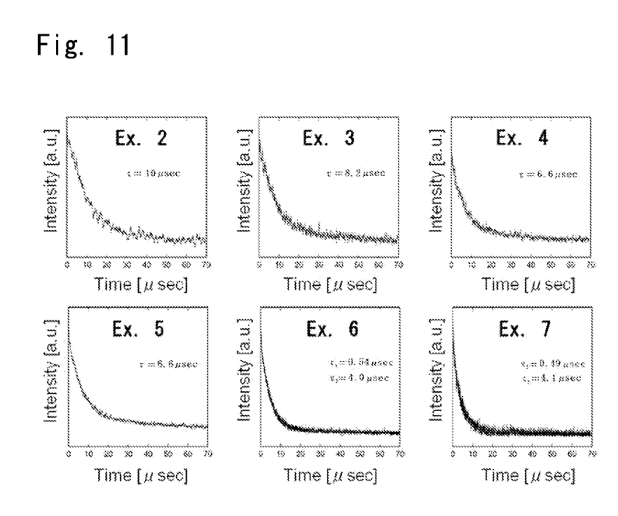

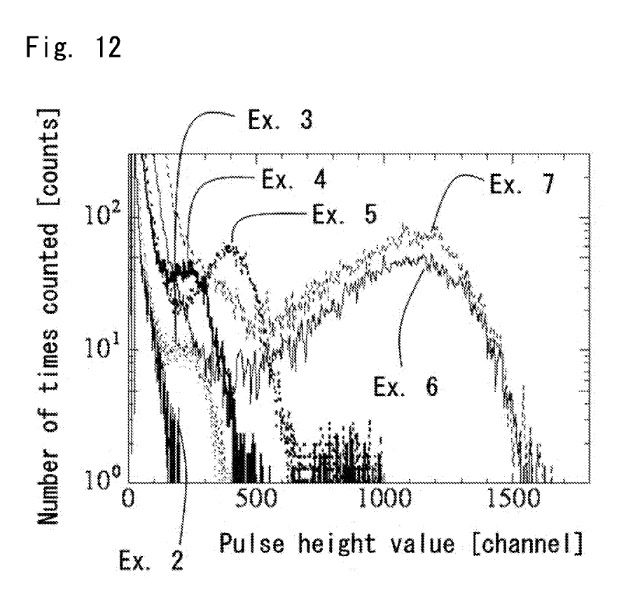

### BRIEF DESCRIPTION OF THE DRAWINGS

[FIG. 1] is a schematic view of an apparatus for producing a crystal by a micro-pulling-down method.

[FIG. 2] shows the powder X-ray diffraction patterns of crystals obtained in Examples 1 to 13.

[FIG. 3] shows the powder X-ray diffraction patterns of crystals obtained in Examples 13 to 17 and Comparative Examples 1 and 2.

[FIG. 4] shows the powder X-ray diffraction patterns of crystals obtained in Examples 13 and 18 to 20 and Comparative Examples 3 to 5.

[FIG. 5] is a schematic view of a device for measuring an X-ray excited light emission spectrum.

[FIG. 6] shows the X-ray excited light emission spectra of the crystals obtained in Examples 1 to 7 and 13.

[FIG. 7] shows the X-ray excited light emission spectra of crystals obtained in Examples 2, 6, 21 and 22.

[FIG. 8] shows the X-ray excited light emission spectra of the crystals obtained in Examples 8 to 20.

[FIG. 9] is a schematic view of a device for measuring a vacuum ultraviolet radiation excited light emission spectrum.

[FIG. 10] shows the vacuum ultraviolet radiation excited light emission spectra of the crystals obtained in Examples 1, 3, 6 and 7.

[FIG. 11] shows the results of measurements of the fluorescence lifetimes of the crystals obtained in Examples 2 to 7.

[FIG. 12] shows the pulse height distribution spectra of the crystals obtained in Examples 2 to 7.

### MODE FOR CARRYING OUT THE INVENTION

The metal fluoride crystal of the present invention represented by the chemical formula K_{3-X}Na_{X}Tm_{YZ}Lu_{Y(1-Z)}F_{3+3Y} where 0.7<X<1.3, 0.85<Y<1.1 and 0.001≦X≦1.0 will be described below. In the present invention, vacuum ultraviolet light emission refers to light emission at a wavelength of 200 nm or less.

The metal fluoride crystal of the present invention has a composition of the metal fluoride crystal represented by the chemical formula K₃LuF₆ in which part of K has been replaced by Na, part of Lu has been replaced by Tm, and the ratio between the total atomic number of K and Na and the total atomic number of Tm and Lu has been changed. In the formula, X denotes the amount of Na relative to the total atomic number of K and Na, and the higher the value of X is, the higher proportion of K is substituted by Na. Y represents the proportion of the total atomic number of Tm and Lu with respect to the total atomic number of K and Na.

Normally, it is impossible to obtain a crystal of a composition in which X or Y has a value outside the above range defined by the present invention, for example, a crystal of the formula K_{1.5}Na_{1.5}TmF₆ or K₂NaTm_{0.5}F_{4.5}.

In crystals grown from raw material powders weighed at such a ratio between the atomic numbers, if a powder X-ray diffraction pattern similar to that of the crystal of the present invention can be confirmed, the crystal of the present invention represented by the above chemical formula having the values of X and Y within the defined range is formed, and a crystal having a crystal structure different from that of the crystal of the present invention is incorporated as a different phase. If the raw material powders are weighed, with X=1.3 as a target, for example, the resulting product will be a mixture of a different phase and a crystal having a crystal structure similar to that of the crystal of the present invention, and a crystal with X=1.3 cannot be obtained.

If X is 0.7 or less or Y is 0.85 or less, excess KF may be contained as a different phase. Generally, KF is known to have strong deliquescent properties, and a mixture containing KF as a different phase undergoes deliquescence. X satisfying 0.9≦X≦1.0 is particularly preferred, because a single-phase crystal is easily obtainable.

Z in the formula is a numerical value representing the proportion of Tm to the sum of Tm and Lu. As the value of Z increases, the proportion of Tm increases, and when Z=1, all of Lu is substituted by Tm. When X=1 and Y=1, high intensity vacuum ultraviolet light emission is obtained at z=0.001 or more. With the crystal in which Z=0.05 to 0.4, vacuum ultraviolet light emission of particularly high intensity is obtained.

In particular, the metal fluoride crystal represented by the above chemical formula where Y=1, 0.9≦X≦1.0 and 0.05≦Z≦0.4, namely, the one represented by the chemical formula K_{3-X}Na_{X}Tm_{Z}Lu_{1-Z}F₆ where 0. 1.0 and 0.05≦Z≦0.4, is preferred, because it provides highly intense vacuum ultraviolet light and is apt to give a single-phase transparent crystal.

With the metal fluoride crystal of the present invention, vacuum ultraviolet light emission at a wavelength of about 190 nm is obtained by excitation with radiation and, as the proportion of Tm increases, the fluorescence lifetime tends to shorten.

The metal fluoride crystal of the present invention represented by the chemical formula K_{3-X}Na_{X}Tm_{YZ}Lu_{Y(1-Z)}F_{3+3Y} where 0.7<X<1.3, 0.85<Y<1.1 and 0.001≦Z≦1.0 has a crystal structure similar to that of a metal fluoride crystal represented by the chemical formula K₂NaYF₆.

The metal fluoride crystal of the present invention may contain a minute amount (5% or less) of metal ions {ions of at least one metal comprising lithium (Li), rubidium (Rb), cesium (Cs), scandium (Sc), yttrium (Y), lanthanum (La), cerium (Ce), praseodymium (Pr), neodymium (Nd), promethium (Pm), samarium (Sm), europium (Eu), gadolinium (Cd), terbium (Tb), dysprosium (Dy), holmium (Ho), erbium (Er), ytterbium or the like), as an impurity, in its crystal structure, unless a crystal phase different from the crystal structure occurs.

The crystal of the present invention may be in any state, a single crystal, a polycrystal, or a crystalline powder, and whichever state it is in, it can cause vacuum ultraviolet light emission. In the case of the monocrystalline state, however, optical transparency is generally so high that light emission from inside, even of a solid sample large in size, is easily withdrawable without being attenuated. Thus, the single crystal is preferred for any of applications as a vacuum ultraviolet light emitting element and a vacuum ultraviolet light emitting scintillator.

A method for producing the metal fluoride crystal of the present invention is not restricted, but the metal fluoride crystal can be produced by a common melt growth method typified by the Czochralski process or the micro-pulling-down method.

The micro-pulling-down method is a method which produces a crystal by pulling out a raw material melt from a hole provided in the bottom of a crucible 5 with the use of a device as shown in FIG. 1. The following is an explanation for a general method for producing the metal fluoride crystal of the present invention by the micro-pulling-down method:

Predetermined amounts of raw materials are charged into the crucible 5 provided with the hole at the bottom. The shape of the hole provided in the bottom of the crucible is not limited, but is preferably a cylindrical shape having a diameter of 0.5 to 4 mm and a length of 0 to 2 mm.

In the present invention, the raw materials are not limited, but it is preferred to use a raw material mixture comprising a mixture of a potassium fluoride (KF) powder, a sodium fluoride (NaF) powder, a thulium fluoride (TmF₃) powder, and lutetium fluoride (LuF₃) powder, each having purity of 99.99% or higher. By using such a raw material mixture, the purity of the resulting crystal can be increased, and characteristics such as light emission intensity are improved. The raw material mixture may be used after being sintered or melted and solidified after mixing.

The mixing ratio of the raw material powders in the raw material mixture is determined by reference to the ratio of the atomic numbers of K, Na, Tm and Lu in the chemical formula K_{3-X}Na_{X}Tm_{YZ}Lu_{Y(1-Z)}F_{3+3Y}, where 0.7<X<1.3, 0.85<Y<1.1 and 0.001≦Z≦1.0, of the desired crystal under the ordinary crystal growth conditions. That is, the mixing ratio of the raw material powders is adjusted such that the ratio of the atomic numbers in the desired metal fluoride crystal composition is achieved. Depending on the crystal growth conditions (for example, if a markedly higher temperature than the melting point is used), however, there may be differences among the amounts of volatilization, during growth, of the respective raw material powders. In this case, the powder which is apt to volatilize needs to be weighed and used in a higher proportion than the composition proportion defined by the chemical formula.

Then, the crucible 5 charged with the above raw materials, an after-heater 1, a heater 2, a heat insulator 3, and a stage 4 are installed as shown in FIG. 1. Using a vacuum evacuator, the interior of a chamber 6 is evacuated to 1.0×10⁻³ Pa or lower. Then, an inert gas such as high purity argon is introduced into the chamber 6 for gas exchange. The pressure within the chamber after gas exchange is not limited, but is generally atmospheric pressure.

By this gas exchange operation, water adhering to the raw materials or the interior of the chamber can be removed, and deterioration of the resulting crystal due to such water can be prevented. To avoid influence due to water which cannot be removed even by the above gas exchange operation, it is preferred to use a solid scavenger such as zinc fluoride, or a gaseous scavenger such as tetrafluoromethane. When the solid scavenger is used, its premixing into the raw materials is a preferred method. When the gaseous scavenger is used, the preferred method is to mix it with the above-mentioned inert gas and introduce the mixture into the chamber.

After the gas exchange operation is performed, the raw materials are heated by a high frequency coil 7 until they are melted. Then, a raw material melt formed by melting is pulled out of the hole at the bottom of the crucible to start the growth of a crystal.

For this purpose, a metal wire is provided at the front end of a pull-down rod, and the metal wire is inserted into the crucible through the hole in the bottom of the crucible. After the raw material melt is caused to adhere to the metal wire, the raw material melt is pulled down together with the metal wire to make the growth of the crystal possible.

That is, with the output of a high frequency wave being adjusted and the temperature of the raw materials being gradually raised, the metal wire is inserted into the hole at the bottom of the crucible, and pulled out. This procedure is repeated until the raw material melt is withdrawn along with the metal wire, to start the growth of the crystal. As the material for the metal wire, any material which substantially does not react with the raw material melt can be used without limitation, but a material excellent in corrosion resistance at high temperatures, such as a W—Re alloy, is preferred.

After the withdrawal of the raw material melt by the metal wire is carried out, the raw material melt is continuously pulled down at a constant pulling-down rate, whereby a crystal can be obtained. The pulling-down rate is not limited, but is preferably in the range of 0.5 to 10 mm/hr. This is because too high a pulling-down rate results in poor crystallinity, whereas too low a pulling-down rate leads to good crystallinity, but requires a huge time for crystal growth.

In the production of the metal fluoride crystal of the present invention, for the purpose of removing a crystal defect ascribed to thermal strain, annealing may be performed after the crystal is produced.

The resulting crystal has satisfactory proccessability, and is easily used after being processed into a desired shape. For its processing, a cutter such as a blade saw or a wire saw, a grinder or a polishing machine, which is publicly known, can be used without limitation. Since the crystal of the present invention is reduced in deliquescent properties, moreover, it can be processed, even when it is not within specially humidity-controlled drying facilities.

The crystal of the present invention has satisfactory vacuum ultraviolet light emission characteristics, and can be allowed to emit light upon excitation with radiation such as X-rays, gamma rays, alpha rays or beta rays, or with vacuum ultraviolet light having a wavelength shorter than a light emission wavelength of 190 nm (e.g., light at a wavelength of 160 nm).

The metal fluoride crystal of the present invention can be processed into a desired shape to serve as the vacuum ultraviolet light emitting element or vacuum ultraviolet light emitting scintillator of the present invention. If it is used as the vacuum ultraviolet light emitting scintillator, for example, the scintillator may be any shape such as plate-shaped or block-shaped, and can be configured as an array having a plurality of quadrangular prism-shaped metal fluoride crystals arranged.

The vacuum ultraviolet light emitting element comprising the metal fluoride crystal of the present invention is combined with a radiation source, which is an excitation source, whereby a vacuum ultraviolet light generator can be constituted. Such a vacuum ultraviolet light generator is preferably used in fields such as photolithography, sterilization, next-generation large-capacity optical disks, and medical care (ophthalmologic treatment, DNA cleavage). Moreover, the scintillator of the present invention can be used preferably as a radiation detector with a low background noise when combined with a vacuum ultraviolet low-light-level photodetector such as a diamond light receiving element or an AlGaN light receiving element.

### EXAMPLES

Hereinbelow, the present invention will be described concretely by reference to its Examples, but the present invention is in no way limited by these Examples. Moreover, not all of combinations of the features described in the Examples are essential to the means for solution to problems that the present invention adopts.

### Examples 1 to 22, Comparative Examples 1 to 5, Reference Example 1

[Preparation of Metal Fluoride Crystal]

Using the crystal producing device shown in FIG. 1, crystals of Examples 1 to 22, Comparative Examples 1 to 5 and Reference Example 1 were prepared.

The method for preparation in Example 1 will be described in detail below. In connection with Examples 2 to 22, Comparative Examples 1 to 5 and Reference Example 1 as well, the same method as in Example 1 was adopted for preparation, except that the weighed values of the respective raw materials shown in Table 1 were different.

As the raw materials, KF, NaF, TmF₃ and LuF₃, each having purity of 99.99%, were used. The after-heater 1, the heater 2, the heat insulator 3, the stage 4, and the crucible 5 used were formed of high purity carbon, and the shape of the hole provided at the bottom of the crucible was a cylindrical shape with a diameter of 2 mm and a length of 0.5 mm.

First, the respective materials were weighed so that the composition of the desired crystal would be achieved. Then, the weighed powders were mixed together thoroughly, and then charged into the crucible 5. Table 1 shows the desired composition, the values of X, Y and Z in the composition, and the amount of the respective raw materials used. The crucible 5 charged with the raw materials was installed above the after-heater 1, and the heater 2 and the heat insulator 3 were sequentially installed around the crucible 5. Then, the interior of the chamber 6 was evacuated under vacuum to 1.0×10⁻⁴ Pa by use of a vacuum evacuation device composed of an oil-sealed rotary vacuum pump and an oil diffusion pump. Then, a 90% argon/10% tetrafluoromethane mixed gas was introduced into the chamber 6 to carry out gas exchange.

The pressure within the chamber 6 after gas exchange was brought to atmospheric pressure, whereafter the raw materials were heated to about 400 degrees by the high frequency coil 7, but no exudation of the raw material melt from the hole at the bottom of the crucible 5 was observed. Thus, the output of the high frequency wave was adjusted to raise the temperature of the raw material melt gradually. During this process, the W—Re wire provided at the front end of the pull-down rod 8 was inserted into the above hole, and pulled down. When this procedure was repeated, it became possible to withdraw the melt of the raw materials from the hole.

The output of the high frequency wave was fixed so that the temperature at this point in time would be maintained, whereupon the melt of the raw materials was pulled down to start crystallization. The melt was continuously pulled down for 12 hours at a rate of 6 mm/hr, and a crystal having a diameter of 2 mm and a length of about 70 mm was obtained finally. In Examples 1 to 22 and Reference Example 1, metal fluoride crystals of the desired compositions shown in Table 1 were obtained. The crystals of Examples 1 to 22 and Reference Example 1 were colorless and transparent, whereas the crystals obtained in Comparative Examples 1 to 5 were whitish.

TABLE 1

| | Desired composition | X | Y | Z | KF[kg] | NaF[g] | TmF₃[g] | LuF₃[g] |
|---|---|---|---|---|---|---|---|---|
| Ex. 1 | K₂NaTm_{0.001}Lu_{0.999}F₆ | 1.0 | 1.0 | 0.001 | 0.596 | 0.215 | 0.001 | 1.188 |
| Ex. 2 | K₂NaTm_{0.01}Lu_{0.99}F₆ | 1.0 | 1.0 | 0.01 | 0.596 | 0.215 | 0.012 | 1.177 |
| Ex. 3 | K₂NaTm_{0.05}Lu_{0.95}F₆ | 1.0 | 1.0 | 0.05 | 0.596 | 0.215 | 0.058 | 1.131 |
| Ex. 4 | K₂NaTm_{0.1}Lu_{0.9}F₆ | 1.0 | 1.0 | 0.1 | 0.597 | 0.216 | 0.116 | 1.072 |
| Ex. 5 | K₂NaTm_{0.2}Lu_{0.8}F₆ | 1.0 | 1.0 | 0.2 | 0.597 | 0.216 | 0.232 | 0.954 |
| Ex. 6 | K₂NaTm_{0.3}Lu_{0.7}F₆ | 1.0 | 1.0 | 0.3 | 0.598 | 0.216 | 0.349 | 0.836 |
| Ex. 7 | K₂NaTm_{0.4}Lu_{0.6}F₆ | 1.0 | 1.0 | 0.4 | 0.599 | 0.217 | 0.466 | 0.718 |
| Ex. 8 | K₂NaTm_{0.5}Lu_{0.5}F₆ | 1.0 | 1.0 | 0.5 | 0.600 | 0.217 | 0.584 | 0.599 |
| Ex. 9 | K₂NaTm_{0.6}Lu_{0.4}F₆ | 1.0 | 1.0 | 0.6 | 0.601 | 0.217 | 0.701 | 0.480 |
| Ex. 10 | K₂NaTm_{0.7}Lu_{0.3}F₆ | 1.0 | 1.0 | 0.7 | 0.602 | 0.218 | 0.820 | 0.361 |
| Ex. 11 | K₂NaTm_{0.8}Lu_{0.2}F₆ | 1.0 | 1.0 | 0.8 | 0.603 | 0.218 | 0.938 | 0.241 |
| Ex. 12 | K₂NaTm_{0.9}Lu_{0.1}F₆ | 1.0 | 1.0 | 0.9 | 0.604 | 0.218 | 1.057 | 0.121 |
| Ex. 13 | K₂NaTmF₆ | 1.0 | 1.0 | 1.0 | 0.605 | 0.219 | 1.176 | 0.000 |
| Comp. Ex. 1 | K_{1.7}Na_{1.3}TmF₆ | 1.3 | 1.0 | 1.0 | 0.521 | 0.288 | 1.191 | 0.000 |
| Ex. 14 | K_{1.8}Na_{1.2}TmF₆ | 1.2 | 1.0 | 1.0 | 0.549 | 0.265 | 1.186 | 0.000 |
| Ex. 15 | K_{1.9}Na_{1.1}TmF₆ | 1.1 | 1.0 | 1.0 | 0.577 | 0.242 | 1.181 | 0.000 |
| Ex. 16 | K_{2.1}Na_{0.9}TmF₆ | 0.9 | 1.0 | 1.0 | 0.633 | 0.196 | 1.171 | 0.000 |
| Ex. 17 | K_{2.2}Na_{0.8}TmF₆ | 0.8 | 1.0 | 1.0 | 0.660 | 0.173 | 1.167 | 0.000 |
| Comp. Ex. 2 | K_{2.3}Na_{0.7}TmF₆ | 0.7 | 1.0 | 1.0 | 0.687 | 0.151 | 1.162 | 0.000 |
| Comp. Ex. 3 | K₂NaTm_{0.8}F_{5.4} | 1.0 | 0.80 | 1.0 | 0.686 | 0.248 | 1.067 | 0.000 |
| Comp. Ex. 4 | K₂NaTm_{0.85}F_{5.55} | 1.0 | 0.85 | 1.0 | 0.664 | 0.240 | 1.097 | 0.000 |
| Ex. 18 | K₂NaTm_{0.9}F_{5.7} | 1.0 | 0.90 | 1.0 | 0.643 | 0.232 | 1.125 | 0.000 |
| Ex. 19 | K₂NaTm_{0.95}F_{5.85} | 1.0 | 0.95 | 1.0 | 0.623 | 0.225 | 1.151 | 0.000 |
| Ex. 20 | K₂NaTm_{1.05}F_{6.15} | 1.0 | 1.05 | 1.0 | 0.588 | 0.212 | 1.200 | 0.000 |
| Comp. Ex. 5 | K₂NaTm_{1.1}F_{6.3} | 1.0 | 1.10 | 1.0 | 0.571 | 0.206 | 1.222 | 0.000 |
| Ex. 21 | K_{2.0625}Na_{0.9375}Tm_{0.0094}Lu_{0.9281}F_{5.8125} | 0.9375 | 0.9375 | 0.01 | 0.636 | 0.209 | 0.011 | 1.143 |
| Ex. 22 | K_{2.0625}Na_{0.9375}Tm_{0.2813}Lu_{0.6563}F_{5.8125} | 0.9375 | 0.9375 | 0.3 | 0.639 | 0.210 | 0.339 | 0.812 |
| Ref. Ex. 5 | K₃LuF₆ | 0.0 | 1.0 | 0.0 | 0.905 | 0.000 | 0.000 | 1.095 |

### [Identification of Crystal Phase]

Identification of the crystal phases of the metal fluoride crystals obtained in Examples 1 to 20 and Comparative Examples 1 to 5 was made by the following method:

Apart of each of the resulting crystals was pulverized to form a powder, which was subjected to powder X-ray diffraction measurement. D8 DISCOVER produced by Bruker AXS was used as a measuring device. Diffraction patterns by the powder X-ray diffraction method are shown in FIGS. 2 to 4. The results of analysis of the diffraction patterns obtained by the powder X-ray diffraction method showed that the crystals of Examples 1 to 20 were crystals having powder X-ray diffraction patterns similar to that of K₂NaYF₆.

FIGS. 3 and 4 showed that the crystals of Comparative Examples 1 to 5 prepared by weighing the raw materials, with X being targeted for 0.7 or less or for 1.3 or more, and Y being targeted for 0.85 or less or for 1.1 or more, were not obtained in a single-phase state, but were confirmed to contain different phases. In conclusion, Comparative Examples 1 to 5 failed to obtain metal fluoride crystals of the desired composition.

The diffraction peaks of the metal fluoride crystals of the present invention obtained in the single phase showed peak shifts conformed to the compositions. Generally, it is recognized that when the site of an element with a small ionic radius is substituted by an element with a large ionic radius, the lattice constant becomes large, and the diffraction peaks shift to a lower angle side. When the site of an element with a large ionic radius is substituted by an element with a small ionic radius, on the other hand, it is admitted that the lattice constant becomes small, and the diffraction peaks shift to a higher angle side. The constituent elements, if arranged in decreasing order of ionic radius, are K>Na>Tm>Lu.

FIG. 2 shows that when Tm was increased with respect to Lu, the diffraction peaks tended to shift to the lower angle side. Thus, it is considered that the lattice constant became large, and Tm substituted for the site of Lu having the same valence number and a smaller ionic radius.

FIG. 3 shows that when K was increased with respect to Na, the diffraction peaks tended to shift to the lower angle side. Thus, it is considered that the lattice constant became large, and K substituted for the site of Na having the same valence number and a smaller ionic radius.

FIG. 4 shows that when Tm was increased with respect to the total atomic number of K and Na, the diffraction peaks tended to shift to the higher angle side. Thus, the lattice constant is considered to have become small. Tm is presumed to have substituted for the site of K or Na having a larger ionic radius. Because of differences in the valence number, however, it is uncertain in what mode Tm was present in the crystal.

In the light of these facts, when a single-phase crystal of a different composition was obtained, it is assumed that a similar structure having some of the elements substituted was formed.

### [Evaluation of Light Emission Characteristics]

Each of the resulting crystals of Examples 1 to 22 was cut to a length of 10 mm by a wire saw, and was then ground at the side surfaces to be processed into a shape 10 mm in length, about 2 mm in width, and 1 mm in thickness. Then, both surfaces, each surface 10 mm long and about 2 mm wide, were mirror-polished to prepare a sample for measurement of the light emission characteristics.

The vacuum ultraviolet light emission characteristics of the processed crystal by X-ray excitation at room temperature were measured in the following manner using a measuring device shown in FIG. 5:

The sample 9 of the present invention was installed at a predetermined position within the measuring device, and the entire interior of the device was purged with a nitrogen gas. X-rays from an X-ray generator 10 (X-ray generator for RIGAKU SA-HFM3), as an excitation source, were directed at the sample 9 at an output of 60 kV and 35 mA, and light emitted from the sample 9 was separated into its constituent spectra by a light emission spectroscope 11 (extreme ultraviolet spectroscope, model KV201, produced by BUNKOUKEIKI Co., Ltd.). The wavelengths of the spectra by the light omission spectroscope 11 were swept within the range of 130 to 250 nm, and the light emission intensities at the respective light emission wavelengths were recorded with a photomultiplier tube 12.

As a result of the above measurements, typical X-ray excited light emission spectra with particularly high light emission intensities in Examples 1 to 22 are shown in FIGS. 6 and 7, and the other X-ray excited light emission spectra in these Examples are shown in FIG. 8. FIGS. 6 to 8 confirmed light emission at a wavelength of about 190 nm in all of the crystals of Examples 1 to 22. From this finding, it was confirmed that the crystals of the present invention emitted light with sufficient intensities at wavelengths of 200 nm or less, and acted as vacuum ultraviolet light emitting elements.

FIG. 6 shows that when X was fixed at 1.0 and Y was fixed at 1.0, higher light emission intensities were obtained in the case of Z having values of 0.05 to 0.4 (Examples 3 to 7).

Example 21 in FIG. 7 shows that even when the value of Z was 0.01, a high light emission intensity similar to those of Examples 3 to 7 (X=1.0, Y=1.0, Z=0.05 to 0.4) was obtained, depending on the values of X and Y.

The light emission characteristics of the processed crystal by vacuum ultraviolet excitation at room temperature were measured in the following manner using a measuring device shown in FIG. 9:

The sample 9 of the present invention was installed at a predetermined position within the measuring device, and the entire interior of the device was purged with a nitrogen gas. Excitation light from a deuterium lamp 13, as an excitation light source, was spectrally separated by an excitation spectroscope 14 to obtain monochromatic light at a wavelength of 159 nm. This excitation light of 159 nm was directed at the sample 9, and light emitted from the sample 9 was separated into its constituent spectra by a light emission spectroscope 11 (extreme ultraviolet spectroscope, model KV201, produced by BUNKOUKEIKI Co., Ltd.). The wavelengths of the spectra by the light omission spectroscope 11 were swept within the range of 160 to 260 nm, and the light emission intensities at the respective light emission wavelengths were recorded with a photomultiplier tube 12.

FIG. 10 shows the light emission spectra of the metal fluoride crystals obtained in Examples 1, 3, 6 and 7. The vacuum ultraviolet light emitting elements of the present invention were confirmed to emit light with sufficient intensities at a wavelength of about 190 nm upon excitation by vacuum ultraviolet radiation of about 160 nm.

### [Evaluation of Scintillator Performance]

The performance, as a scintillator, of the metal fluoride crystal of the present invention was evaluated by the following method:

The mirror-polished surface of each of the crystals of Examples 2 to 7 (with varying Tm concentration) processed into the same shape as that the sample for measurement of the light emission characteristics was bonded to a photoelectric surface of a photomultiplier tube (R8778, produced by HAMAMATSU PHOTONICS K. K.). Then, a ²⁴¹Am sealed radiation source having radioactivity of 4 MBq was installed at a position as close as possible to a surface of the crystal opposite to its surface bonded to the photoelectric surface, whereby the scintillator was brought into the state of irradiation with alpha rays. Then, a light shielding sheet was applied to block light entering from the outside.

Then, in order to measure scintillation light emitted from the crystal, the scintillation light was converted into electrical signals via the photomultiplier tube to which a high voltage of 1300 V was applied. The electrical signals outputted from the photomultiplier tube are pulsed signals reflecting the scintillation light. The pulse height of the pulsed signal represents the light emission intensity of the scintillation light, while the waveform thereof shows an attenuation curve based on the fluorescence lifetime of the scintillation light. The attenuation curves of the electrical signals outputted from the photomultiplier tube were read using an oscilloscope, and shown in FIG. 11. FIG. 11 shows that the crystals of Examples 2 to 7 had fluorescence lifetimes detectable by a photomultiplier tube and could be used as scintillators.

The fluorescence lifetime represents the period of time from the occurrence of light omission until the attenuation of the light emission intensity to 1/e. The fluorescence lifetimes of Examples 2 to 7 were determined by the fitting of the attenuation curves. The fitting refers to determining the variables of a theoretical equation, which coincides with the actual attenuation curve, by use of computer software, and can be performed using computer software built generally for graph making or data analysis.

The equation used for the fitting was I(t)=A exp(&#8722; t/τ) where I(t): light emission intensity at time t, A: initial light emission intensity, τ: fluorescence lifetime. If the fitting was difficult with an equation involving a single-component fluorescence lifetime, however, a two-component equation I(t)=A₁ exp(&#8722; t/τ₁)+A₂ exp(&#8722; t/τ₂) was adopted for fitting.

In Examples 2 to 5, τ=10μ seconds, 8.2μ seconds, 6.6μ seconds, and 6.6μ seconds, respectively. In Example 6, τ₁=0.54μ second, τ₂=4.0μ seconds. In Example 7, τ₁=0.49μ second, τ₂=4.1μ seconds. These findings show that as the content of Tm increased, the fluorescence lifetime generally tended to shorten.

The fluorescence lifetime of a scintillator affects the time resolution (the number of times radiation can be detected per unit time) of a radiation detector incorporating the scintillator. By optionally increasing the Tm concentration in the crystal, therefore, the time resolution can be improved.

In connection with Examples 2 to 7, the electrical signals outputted from the photomultiplier tube were shaped and amplified by a shaping amplifier, and entered into a multichannel pulse height analyzer to analyze them and prepare pulse height distribution spectra. The resulting pulse height distribution spectra are shown in FIG. 12. The abscissa of the pulse height distribution spectrum represents the pulse height value of the electrical signal, namely, the pulse height of the electrical signal determined by the amount of light emission of scintillation light. The ordinate represents the frequency of the electrical signal showing each pulse height value.

In a region where the pulse height value of the pulse height distribution spectrum was in the channels 100 to 1,500, a clear peak ascribed to scintillation light was observed, and could be separated from a background noise present in a region where the pulse height value of the pulse height distribution spectrum was in the channels 0 to 100. Thus, the crystal of the present invention was found to be a scintillator having a sufficient amount of light emission.

### [Evaluation of Deliquescent Properties]

The deliquescent properties of a crystal K₃LuF₆ (Reference Example 1) before part of K was replaced by Na and part of Lu was replaced by Tm for the preparation of the metal fluoride crystal of the present invention were compared with the deliquescent properties of the crystals of Examples 1 to 22.

Deliquescence is a phenomenon in which a solid takes in water contained in an atmosphere to become an aqueous solution. Therefore, the crystals of Examples 1 to 22 and Reference Example 1 (solids each ground to 1 by 2 by 10 mm and polished) were simultaneously allowed to stand in the same place for about 1 hour in the air at an atmospheric temperature of about 25° C. and a humidity of about 70%, and then compared. No change was observed in the crystals of Examples 1 to 22, whereas water was confirmed to lie on the crystal surface in the crystal of Reference Example 1.

Next, in order to investigate the influence of water on the crystal more clearly, 2 bottles each containing about 100 ml of pure water were rendered ready for use, and charged with the crystal of Example 1 and the crystal of Reference Example 1, respectively. When the bottles were shaken thoroughly for stirring, the crystal of Example 1 remained unchanged. On the other hand, the crystal of Reference Example 1 partly dissolved, lost shape, and broke into pieces upon stirring for a sufficient time. These findings show that the metal fluoride crystal of the present invention was minimally influenced by water as compared with the crystal of Reference Example 1.

### EXPLANATIONS OF LETTERS OR NUMERALS:

1 After-heater

2 Heater

3 Heat insulator

4 Stage

5 Crucible

6 Chamber

7 High frequency coil

8 Pull-down rod

9 Sample

10 X-ray generator

11 Light emission spectroscope

12 Photomultiplier tube

13 Deuterium lamp

14 Excitation spectroscope

1. A metal fluoride crystal represented by a chemical formula K_{3-X}Na_{X}Tm_{YZ}Lu_{Y(1-Z)}F_{3+3Y} where 0.7<X<1.3, 0.85<Y<1.1 and 0.001≦Z≦1.0.

2. The metal fluoride crystal according to claim 1, which is represented by a chemical formula K_{3-X}Na_{X}Tm_{Z}Lu_{1-Z}F₆ where 0.9≦X≦1.0 and 0.05<Z<0.4.

3. A vacuum ultraviolet light emitting element composed of the metal fluoride crystal according to claim 1.

4. A vacuum ultraviolet light emitting scintillator composed of the metal fluoride crystal according to claim 1.
